(19) United States
(12) Patent Application Publication
(10) Pub. No.: US 2011/0164027 A1
(43) Pub. Date: Jul. 7, 2011

(54) METHOD OF DETECTING CHANGE IN DISPLAY DATA

(75) Inventor: Robert L. Grieb, San Diego, CA (US)

(73) Assignee: QUALCOMM MEMS Technologies, Inc., San Diego, CA (US)

(21) Appl. No.: 12/683,298

(22) Filed: Jan. 6, 2010

(51) Int. Cl. G06T 1/00; G09G 5/36

(52) U.S. Cl. 345/418; 345/545

(57) ABSTRACT

An apparatus and method for updating a display are disclosed. Identifying values are determined for units of display data. Identifying values for units of display data received during an update are compared to identifying values for previously received units of display data. Depending on the comparison, the update of the corresponding portion of the display may be skipped.

### BACKGROUND

1. Field of the Invention

The present invention relates to systems and methods for updating a display apparatus.

2. Description of Related Technology

Electromechanical systems (EMS) include mechanical elements, actuators, and electronics. Mechanical elements may be created using deposition, etching, and or other machining processes that etch away parts of substrates and/or deposited material layers or that add layers to form electrical and electromechanical devices. One type of EMS device is called an interferometric modulator. As used herein, the term interferometric modulator or interferometric light modulator refers to a device that selectively absorbs and/or reflects light using the principles of optical interference. In certain embodiments, an interferometric modulator may comprise a pair of conductive plates, one or both of which may be transparent and/or reflective in whole or part and capable of relative motion upon application of an appropriate electrical signal. In a particular embodiment, one plate may comprise a stationary layer deposited on a substrate and the other plate may comprise a metallic membrane separated from the stationary layer by an air gap. As described herein in more detail, the position of one plate in relation to another can change the optical interference of light incident on the interferometric modulator. Such devices have a wide range of applications, and it would be beneficial in the art to utilize and/or modify the characteristics of these types of devices so that their features can be exploited in improving existing products and creating new products that have not yet been developed.

### SUMMARY

The system, method, and devices of the invention each have several aspects, no single one of which is solely responsible for its desirable attributes. Without limiting the scope of this invention, its more prominent features will now be discussed briefly. After considering this discussion, and particularly after reading the section entitled “Detailed Description of Preferred Embodiments” one will understand how the features of this invention provide advantages over other display devices.

One aspect of the invention includes a method of updating a display. The method includes obtaining a first identifying value corresponding to a first unit of display data, obtaining a second identifying value corresponding to a second unit of display data, comparing the first and second identifying values, and selectively writing the first unit of display data to a display based, at least in part, on the comparison.

Another aspect of the invention includes a display apparatus. The display apparatus comprises a memory storing one or more identifying values corresponding to respective units of display data. The identifying values comprise less data than the corresponding units of display data. The display apparatus also comprises a frame buffer storing the corresponding units of display data.

Another aspect of the invention includes an apparatus for updating a display. The apparatus comprises means for obtaining a first identifying value corresponding to a first unit of display data, means for obtaining a second identifying value corresponding to a second unit of display data, means for comparing the first and second identifying values, and means for selectively writing the first unit of display data to a display based, at least in part, on the comparison.

Another aspect of the invention comprises a computer program product. The computer program product comprises a computer-readable medium having stored thereon, computer executable instructions that, if executed by an apparatus, cause the apparatus to perform a method. The method comprises obtaining a first identifying value corresponding to a first unit of display data, obtaining a second identifying value corresponding to a second unit of display data, comparing the first and second identifying values, and selectively writing the first unit of display data to a display based, at least in part, on the comparison.

### BRIEF DESCRIPTION OF THE DRAWINGS

FIG. 1 is an isometric view depicting a portion of one embodiment of an interferometric modulator display in which a movable reflective layer of a first interferometric modulator is in a relaxed position and a movable reflective layer of a second interferometric modulator is in an actuated position.

FIG. 2 is a system block diagram illustrating one embodiment of an electronic device incorporating a 3×3 interferometric modulator display.

FIG. 3 is a diagram of movable mirror position versus applied voltage for one exemplary embodiment of an interferometric modulator of FIG. 1.

FIG. 4 is an illustration of a set of row and column voltages that may be used to drive an interferometric modulator display.

FIGS. 5A and 5B illustrate one exemplary timing diagram for row and column signals that may be used to write a frame of display data to the 3×3 interferometric modulator display of FIG. 2.

FIGS. 6A and 6B are system block diagrams illustrating an embodiment of a visual display device comprising a plurality of interferometric modulators.

FIG. 7A is a cross section of the device of FIG. 1.

FIG. 7B is a cross section of an alternative embodiment of an interferometric modulator.

FIG. 7C is a cross section of another alternative embodiment of an interferometric modulator.

FIG. 7D is a cross section of yet another alternative embodiment of an interferometric modulator.

FIG. 7E is a cross section of an additional alternative embodiment of an interferometric modulator.

FIGS. 8A, 8B, and 8C illustrate an exemplary update sequence for a display system.

FIG. 9 is a system block diagram illustrating an embodiment of an update apparatus.

FIG. 10 is a flowchart of an embodiment of a process of updating a display.

### DETAILED DESCRIPTION OF THE PREFERRED EMBODIMENTS

The following detailed description is directed to certain specific embodiments. However, the teachings herein can be applied in a multitude of different ways. In this description, reference is made to the drawings wherein like parts are designated with like numerals throughout. The embodiments may be implemented in any device that is configured to display an image, whether in motion (e.g., video) or stationary (e.g., still image), and whether textual or pictorial. More particularly, it is contemplated that the embodiments may be implemented in or associated with a variety of electronic devices such as, but not limited to, mobile telephones, wireless devices, personal data assistants (PDAs), hand-held or portable computers, GPS receivers/navigators, cameras, MP3 players, camcorders, game consoles, wrist watches, clocks, calculators, television monitors, flat panel displays, computer monitors, auto displays (e.g., odometer display, etc.), cockpit controls and/or displays, display of camera views (e.g., display of a rear view camera in a vehicle), electronic photographs, electronic billboards or signs, projectors, architectural structures, packaging, and aesthetic structures (e.g., display of images on a piece of jewelry). EMS devices of similar structure to those described herein can also be used in non-display applications such as in electronic switching devices.

Conventional approaches to reducing power consumption in EMS display devices have included various techniques that each tends to compromise the user experience by decreasing the quality of the image displayed to the user. These approaches have included decreasing the resolution or complexity of displayed images, decreasing the number of images in the sequence over a given time period, and decreasing the grayscale or color intensity depth of the image. Other suggestions have been made to reduce power consumption by different methods of addressing the display, however, they have been too complex, such that they require more power to solve the computation than power saved from the addressing of the display. Methods and devices are described herein which are configured to reduce power consumption by determining which portions of a display update can be skipped without degrading user experience. In particular, low power systems and methods are presented for determining when display data has changed.

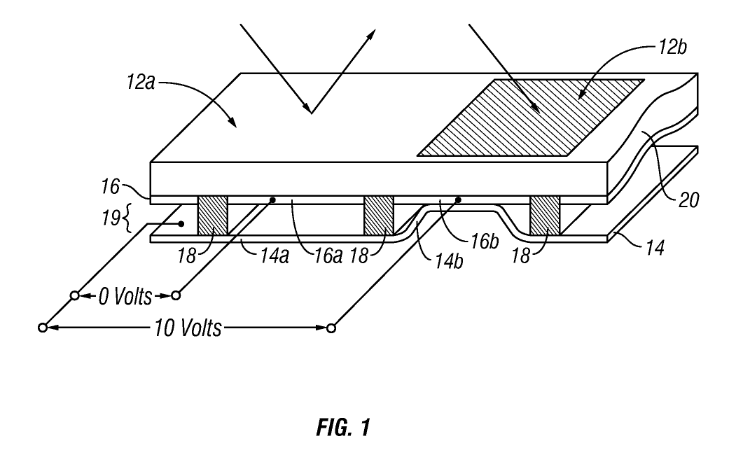

One interferometric modulator display embodiment comprising an interferometric EMS display element is illustrated in FIG. 1. In these devices, the pixels are in either a bright or dark state. In the bright (“relaxed” or “open”) state, the display element reflects a large portion of incident visible light to a user. When in the dark (“actuated” or “closed”) state, the display element reflects little incident visible light to the user. Depending on the embodiment, the light reflectance properties of the “on” and “off” states may be reversed. EMS pixels can be configured to reflect predominantly at selected colors, allowing for a color display in addition to black and white.

FIG. 1 is an isometric view depicting two adjacent pixels in a series of pixels of a visual display, wherein each pixel comprises a EMS interferometric modulator. In some embodiments, an interferometric modulator display comprises a row/column array of these interferometric modulators. Each interferometric modulator includes a pair of reflective layers positioned at a variable and controllable distance from each other to form a resonant optical gap with at least one variable dimension. In one embodiment, one of the reflective layers may be moved between two positions. In the first position, referred to herein as the relaxed position, the movable reflective layer is positioned at a relatively large distance from a fixed partially reflective layer. In the second position, referred to herein as the actuated position, the movable reflective layer is positioned more closely adjacent to the partially reflective layer. Incident light that reflects from the two layers interferes constructively or destructively depending on the position of the movable reflective layer, producing either an overall reflective or non-reflective state for each pixel.

The depicted portion of the pixel array in FIG. 1 includes two adjacent interferometric modulators 12a and 12b. In the interferometric modulator 12a on the left, a movable reflective layer 14a is illustrated in a relaxed position at a predetermined distance from an optical stack 16a, which includes a partially reflective layer. In the interferometric modulator 12b on the right, the movable reflective layer 14b is illustrated in an actuated position adjacent to the optical stack 16b.

The optical stacks 16a and 16b (collectively referred to as optical stack 16), as referenced herein, typically comprise several fused layers, which can include an electrode layer, such as indium tin oxide (ITO), a partially reflective layer, such as chromium, and a transparent dielectric. The optical stack 16 is thus electrically conductive, partially transparent and partially reflective, and may be fabricated, for example, by depositing one or more of the above layers onto a transparent substrate 20. The partially reflective layer can be formed from a variety of materials that are partially reflective such as various metals, semiconductors, and dielectrics. The partially reflective layer can be formed of one or more layers of materials, and each of the layers can be formed of a single material or a combination of materials.

In some embodiments, the layers of the optical stack 16 are patterned into parallel strips, and may form column electrodes in a display device as described further below. The movable reflective layers 14a, 14b may be formed as a series of parallel strips of a deposited metal layer or layers (orthogonal to the column electrodes of 16a, 16b) to form rows deposited on top of posts 18 and an intervening sacrificial material deposited between the posts 18. When the sacrificial material is etched away, the movable reflective layers 14a, 14b are separated from the optical stacks 16a, 16b by a defined gap 19. A highly conductive and reflective material such as aluminum may be used for the reflective layers 14, and these strips may form row electrodes in a display device. Note that FIG. 1 may not be to scale. In some embodiments, the spacing between posts 18 may be on the order of 10-100 um, while the gap 19 may be on the order of <1000 Angstroms.

With no applied voltage, the gap 19 remains between the movable reflective layer 14a and optical stack 16a, with the movable reflective layer 14a in a mechanically relaxed state, as illustrated by the pixel 12a in FIG. 1. However, when a potential (voltage) difference is applied to a selected row and column, the capacitor formed at the intersection of the row and column electrodes at the corresponding pixel becomes charged, and electrostatic forces pull the electrodes together. If the voltage is high enough, the movable reflective layer 14 is deformed and is forced against the optical stack 16. A dielectric layer (not illustrated in this Figure) within the optical stack 16 may prevent shorting and control the separation distance between layers 14 and 16, as illustrated by actuated pixel 12b on the right in FIG. 1. The behavior is the same regardless of the polarity of the applied potential difference.

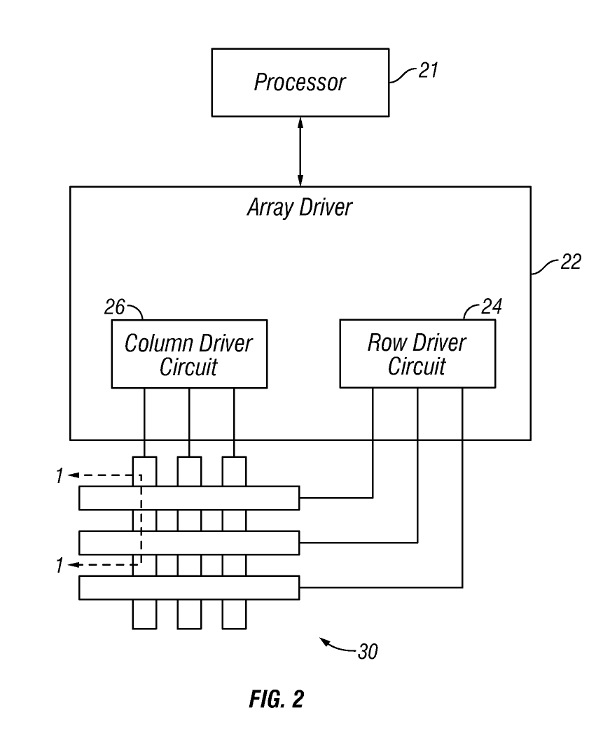

FIGS. 2 through 5 illustrate one exemplary process and system for using an array of interferometric modulators in a display application.

FIG. 2 is a system block diagram illustrating one embodiment of an electronic device that may incorporate interferometric modulators. The electronic device includes a processor 21 which may be any general purpose single- or multi-chip microprocessor such as an ARM®, Pentium®, 8051, MIPS®, Power PC®, or ALPHA®, or any special purpose microprocessor such as a digital signal processor, microcontroller, or a programmable gate array. As is conventional in the art, the processor 21 may be configured to execute one or more software modules. In addition to executing an operating system, the processor may be configured to execute one or more software applications, including a web browser, a telephone application, an email program, or any other software application.

In one embodiment, the processor 21 is also configured to communicate with an array driver 22. In one embodiment, the array driver 22 includes a row driver circuit 24 and a column driver circuit 26 that provide signals to a display array or panel 30. The cross section of the array illustrated in FIG. 1 is shown by the lines 1-1 in FIG. 2. Note that although FIG. 2 illustrates a 3×3 array of interferometric modulators for the sake of clarity, the display array 30 may contain a very large number of interferometric modulators, and may have a different number of interferometric modulators in rows than in columns (e.g., 300 pixels per row by 190 pixels per column).

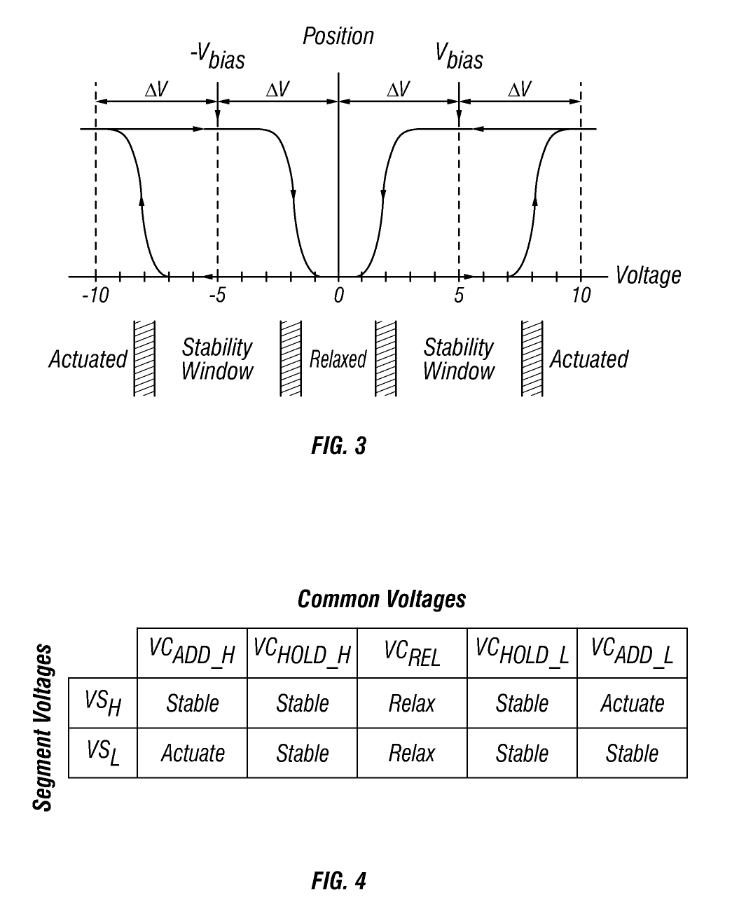

FIG. 3 is a diagram of movable mirror position versus applied voltage for one exemplary embodiment of an interferometric modulator of FIG. 1. For EMS interferometric modulators, the row/column actuation protocol may take advantage of a hysteresis property of these devices as illustrated in FIG. 3. An interferometric modulator may require, for example, a 10 volt potential difference to cause a movable layer to deform from the relaxed state to the actuated state. However, when the voltage is reduced from that value, the movable layer maintains its state as the voltage drops back below 10 volts. In the exemplary embodiment of FIG. 3, the movable layer does not relax completely until the voltage drops below 2 volts. There is thus a range of voltage, about 3 to 7 V in the example illustrated in FIG. 3, where there exists a window of applied voltage within which the device is stable in either the relaxed or actuated state. This is referred to herein as the “hysteresis window” or “stability window.” For a display array having the hysteresis characteristics of FIG. 3, the row/column actuation protocol can be designed such that during row strobing, pixels in the strobed row that are to be actuated are exposed to a voltage difference of about 10 volts, and pixels that are to be relaxed are exposed to a voltage difference of close to zero volts. After the strobe, the pixels are exposed to a steady state or bias voltage difference of about 5 volts such that they remain in whatever state the row strobe put them in. After being written, each pixel sees a potential difference within the “stability window” of 3-7 volts in this example. This feature makes the pixel design illustrated in FIG. 1 stable under the same applied voltage conditions in either an actuated or relaxed pre-existing state. Since each pixel of the interferometric modulator, whether in the actuated or relaxed state, is essentially a capacitor formed by the fixed and moving reflective layers, this stable state can be held at a voltage within the hysteresis window with almost no power dissipation. Essentially no current flows into the pixel if the applied potential is fixed.

As described further below, in typical applications, a frame of an image may be created by sending a set of data signals (each having a certain voltage level) across the set of column electrodes in accordance with the desired set of actuated pixels in the first row. A row pulse is then applied to a first row electrode, actuating the pixels corresponding to the set of data signals. The set of data signals is then changed to correspond to the desired set of actuated pixels in a second row. A pulse is then applied to the second row electrode, actuating the appropriate pixels in the second row in accordance with the data signals. The first row of pixels are unaffected by the second row pulse, and remain in the state they were set to during the first row pulse. This may be repeated for the entire series of rows in a sequential fashion to produce the frame. Generally, the frames are refreshed and/or updated with new image data by continually repeating this process at some desired number of frames per second. A wide variety of protocols for driving row and column electrodes of pixel arrays to produce image frames may be used.

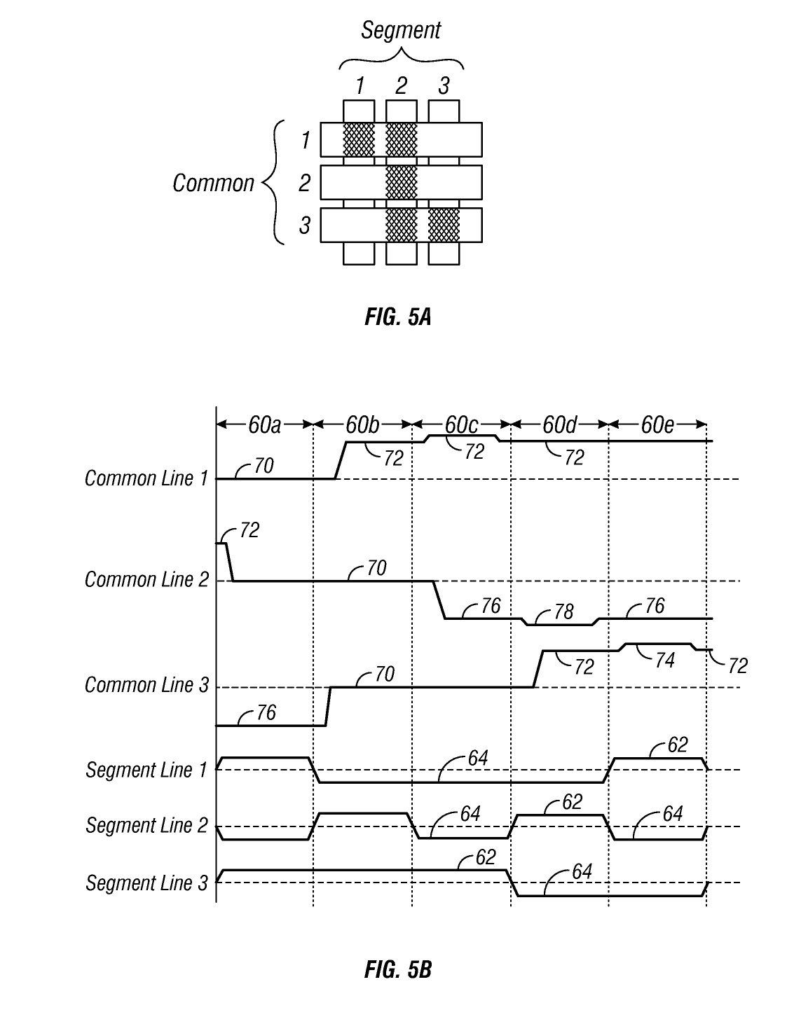

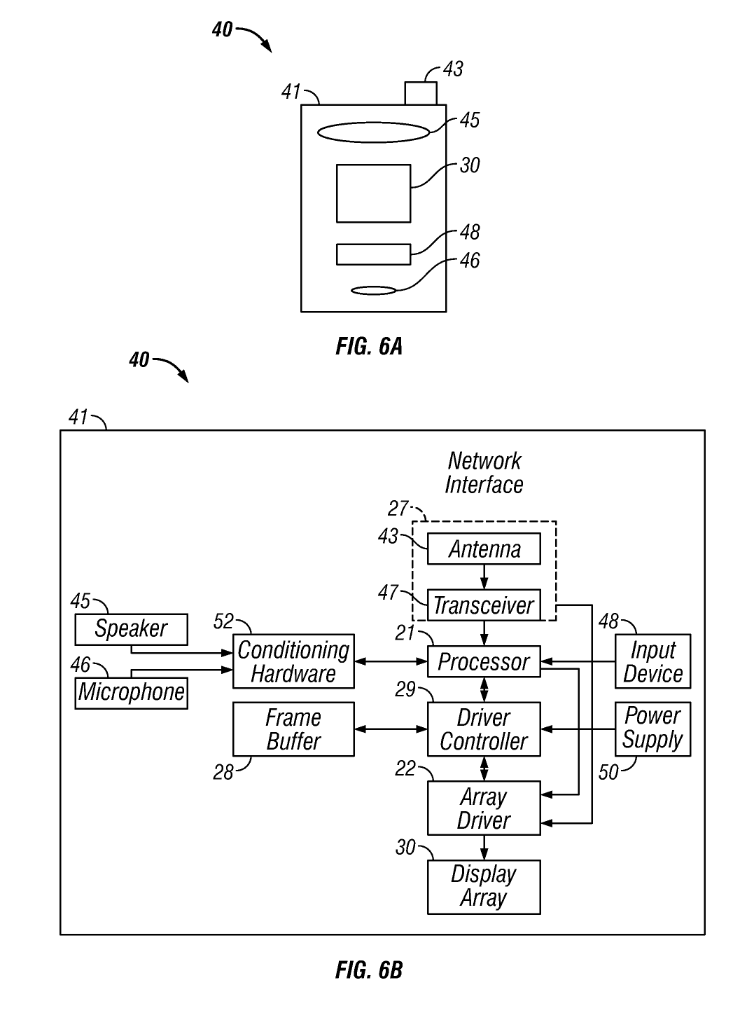

FIGS. 4 and 5 illustrate one possible actuation protocol for driving an array of electromechanical devices such as an array of interferometric modulators. FIG. 4 illustrates a possible set of column and row voltage levels that may be used for modulators exhibiting the hysteresis properties illustrated in FIG. 3. In the embodiment of FIG. 4 (also see FIG. 5A), as many as five or more possible voltages may be applied along a common line (which may be either a row or column line, in various embodiments) in order to address specific common lines, and at least two possible voltages may be applied along segment lines to write data to the common line(s) currently being addressed.

When a release voltage VC_{REL} is applied along a common line, all interferometric modulator elements along the common line will be placed in a relaxed state, alternatively referred to as a released or unactuated state, regardless of the voltage applied along the segment lines. The release voltage VC_{REL} and the high and low segment voltages VS_{H} and VS_{L} are selected accordingly. In particular, when the release voltage VC_{REL} is applied along a common line, the potential voltage across the modulator (alternatively referred to as a pixel voltage) is within the relaxation window (see FIG. 3, also referred to as a release window) both when the high segment voltage VS_{H} and the low segment voltage VS_{L} are applied along the corresponding segment line. The difference between the high and low segment voltage, also referred to as the segment voltage swing, is less than the width of the relaxation window.

When a hold voltage is applied on a common line, such as a high hold voltage VC_{HOLD}_{_{—}}_{H} or a low hold voltage VC_{HOLD}_{_{—}}_{L}, the state of the interferometric modulator will remain constant. VC_{HOLD}_{_{—}}_{H} and VC_{HOLD}_{_{—}}_{L} may also be referred to as a positive and negative hold voltage respectively. A relaxed modulator will remain in a relaxed position, and an actuated modulator will remain in an actuated position. The hold voltages are selected such that the pixel voltage will remain within a stability window of the interferometric modulator both when the high segment voltage VS_{H} and the low segment voltage VS_{L} are applied along the corresponding segment line. The segment voltage swing is thus less than the width of either the positive or the negative stability window.

When an addressing voltage is applied on a common line, such as high addressing voltage VC_{ADD}_{_{—}}_{H} or low addressing voltage VC_{ADD}_{_{—}}_{L}, data can be selectively written to the modulators along that line by application of segment voltages along the respective segment lines. VC_{ADD}_{_{—}}_{H} and VC_{ADD}_{_{—}}_{L}, may also be referred to as positive and negative address voltages respectively. The addressing voltages are selected such that when an addressing voltage is applied along a common line, the pixel voltage will be within a stability window when one of the segment voltages is applied along the segment line, but beyond the stability window when the other is applied, causing actuation of the pixel. The particular segment voltage which causes actuation will vary depending upon which addressing voltage is used. When the high addressing voltage VC_{ADD}_{_{—}}_{H} is applied along the common line, application of the high segment voltage VS_{H} will cause a modulator to remain in its current position, while application of the low segment voltage VS_{L} causes actuation of the modulator. The effect of the segment voltages will be the opposite when a low addressing voltage VC_{ADD}_{_{—}}_{L} is applied, with high segment voltage VS_{H} causing actuation of the modulator, and low segment voltage VS_{L} having no effect on the state of the modulator.

In certain embodiments, only a high or a low hold voltage and address voltage may be used. Using both positive and negative hold and address voltages, however, allows the polarity of write procedures to be alternated, inhibiting charge accumulation which could occur after write operations of only a single polarity.

FIG. 5B is a timing diagram showing a series of common and segment voltage signals applied to the 3×3 array of FIG. 2 which will result in the display arrangement illustrated in FIG. 5A, where actuated modulators are non-reflective and illustrated as dark. Prior to writing the frame illustrated in FIG. 5A, the pixels can be in any state, but the write procedure illustrated in the timing diagram of FIG. 5B releases each modulator in a given common line prior to addressing the common line.

During the first line time 60a, none of common lines 1, 2, or 3 are being addressed. A release voltage 70 is applied on common line 1. The voltage applied on common line 2 begins at a high hold voltage 72 and moves to a release voltage 70. A low hold voltage 76 is applied along common line 3. Thus, the modulators (1,1), (1,2), and (1,3) along common line 1 remain in a relaxed state for the duration of the first line time 60a, the modulators (2,1), (2,2), and (2,3) along common line 2 will move to a relaxed state, and the modulators (3,1), (3,2), and (3,3) along common line 3 will remain in their previous state. The segment voltages applied along segment lines 1, 2, and 3 will have no effect on the state of the interferometric modulators, as none of common lines 1, 2, or 3 are being addressed during line time 60a.

During the second line time 60b, the voltage on common line 1 moves to a high hold voltage 72, and all modulators along common line 1 remain in a relaxed state regardless of the segment voltage applied. The modulators along common line 2 remain in a relaxed state, and the modulators (3,1), (3,2), and (3,3) along common line 3 will relax when the voltage along common line 3 moves to a release voltage 70.

During the third line time 60c, common line 1 is addressed by applying a high address voltage 74 on common line 1. Because a low segment voltage 64 is applied along segment lines 1 and 2 during the application of this address voltage, the pixel voltage across modulators (1,1) and (1,2) is greater than the positive stability window of the modulators, and modulators (1,1) and (1,2) are actuated. Because a high segment voltage 62 is applied along segment line 3, the pixel voltage across modulator (1,3) is less than that of modulators (1,1) and (1,2), and is within the positive stability window of the modulator. Modulator (1,3) thus remains relaxed. Also during line time 60c, the voltage along common line 2 decreases to a low hold voltage 76, and the voltage along common line 3 remains at a release voltage, leaving the modulators along common lines 2 and 3 in a relaxed position.

During the fourth line time 60d, the voltage on common line 1 is at a high hold voltage 72, leaving the modulators along common line 1 in their respective addressed states. Common line 2 is now addressed by decreasing the voltage on common line 2 to a low address voltage 78. Because a high segment voltage 62 is applied along segment line 2, the pixel voltage across modulator (2,2) is below the negative stability window of the modulator, causing the modulator (2,2) to actuate. Because a low segment voltage 64 is applied along segment lines 1 and 3, the modulators (2,1) and (2,3) remain in a relaxed position. The voltage on common line 3 increases to a high hold voltage 72, leaving the modulators along common line 3 in a relaxed state.

Finally, during the fifth line time 60e, the voltage on common line 1 remains at high hold voltage 72, and the voltage on common line 2 remains at a low hold voltage, leaving the modulators along common lines 1 and 2 in their respective addressed states. The voltage on common line 3 increases to a high address voltage to address the modulators along common line 3. As a low segment voltage 64 is applied on segment lines 2 and 3, the modulators (3,2) and (3,3) actuate, while the high segment voltage 62 applied along segment line 1 causes modulator (3,1) to remain in a relaxed position. Thus, at the end of the fifth hold time 60e, the 3×3 pixel array is in the state shown in FIG. 5A, and will remain in that state as long as the hold voltages are applied along the common lines, regardless of variations in the segment voltage which may occur when modulators along other common lines (not shown) are being addressed.

In the timing diagram of FIG. 5B, it can be seen that a given write procedure includes the use of either high hold and address voltages, or low hold and address voltages. Once a high or low hold voltage is applied, the pixel voltage remains within or beyond a given stability window, and does not pass through the relaxation window until a release voltage is applied. Furthermore, as each modulator is released as part of the write procedure prior to addressing the modulator, the actuation time of a modulator, rather than the release time, determines the necessary line time. In embodiments in which the release time of a modulator is greater than the actuation time, the release voltage may be applied for longer than a single line time, as depicted in FIG. 5B. In further embodiments, voltages applied along common lines or segment lines may vary to account for variations in the actuation and release voltages of different modulators, such as modulators of different colors.

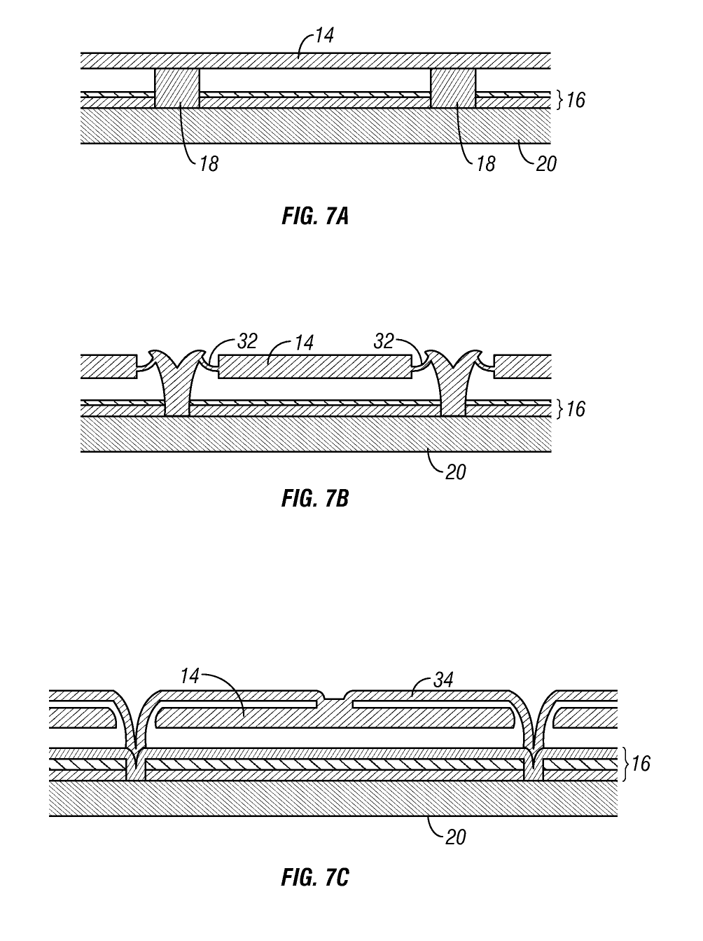

FIGS. 6A and 6B are system block diagrams illustrating an embodiment of a display device 40. The display device 40 can be, for example, a cellular or mobile telephone. However, the same components of display device 40 or slight variations thereof are also illustrative of various types of display devices such as televisions and portable media players.

The display device 40 includes a housing 41, a display 30, an antenna 43, a speaker 45, an input device 48, and a microphone 46. The housing 41 is generally formed from any of a variety of manufacturing processes, including injection molding, and vacuum forming. In addition, the housing 41 may be made from any of a variety of materials, including but not limited to plastic, metal, glass, rubber, and ceramic, or a combination thereof. In one embodiment the housing 41 includes removable portions (not shown) that may be interchanged with other removable portions of different color, or containing different logos, pictures, or symbols.

The display 30 of exemplary display device 40 may be any of a variety of displays, including a bi-stable display, as described herein. In other embodiments, the display 30 includes a flat-panel display, such as plasma, EL, OLED, STN LCD, or TFT LCD as described above, or a non-flat-panel display, such as a CRT or other tube device. However, for purposes of describing the present embodiment, the display 30 includes an interferometric modulator display, as described herein.

The components of one embodiment of exemplary display device 40 are schematically illustrated in FIG. 6B. The illustrated exemplary display device 40 includes a housing 41 and can include additional components at least partially enclosed therein. For example, in one embodiment, the exemplary display device 40 includes a network interface 27 that includes an antenna 43 which is coupled to a transceiver 47. The transceiver 47 is connected to a processor 21, which is connected to conditioning hardware 52. The conditioning hardware 52 may be configured to condition a signal (e.g. filter a signal). The conditioning hardware 52 is connected to a speaker 45 and a microphone 46. The processor 21 is also connected to an input device 48 and a driver controller 29. The driver controller 29 is coupled to a frame buffer 28, and to an array driver 22, which in turn is coupled to a display array 30. A power supply 50 provides power to all components as required by the particular exemplary display device 40 design.

The network interface 27 includes the antenna 43 and the transceiver 47 so that the exemplary display device 40 can communicate with one or more devices over a network. In one embodiment the network interface 27 may also have some processing capabilities to relieve requirements of the processor 21. The antenna 43 is any antenna for transmitting and receiving signals. In one embodiment, the antenna transmits and receives RF signals according to the IEEE 802.11 standard, including IEEE 802.11(a), (b), or (g). In another embodiment, the antenna transmits and receives RF signals according to the BLUETOOTH standard. In the case of a cellular telephone, the antenna is designed to receive CDMA, GSM, AMPS, W-CDMA, or other known signals that are used to communicate within a wireless cell phone network. The transceiver 47 pre-processes the signals received from the antenna 43 so that they may be received by and further manipulated by the processor 21. The transceiver 47 also processes signals received from the processor 21 so that they may be transmitted from the exemplary display device 40 via the antenna 43.

In an alternative embodiment, the transceiver 47 can be replaced by a receiver. In yet another alternative embodiment, network interface 27 can be replaced by an image source, which can store or generate image data to be sent to the processor 21. For example, the image source can be a digital video disc (DVD) or a hard-disc drive that contains image data, or a software module that generates image data.

Processor 21 generally controls the overall operation of the exemplary display device 40. The processor 21 receives data, such as compressed image data from the network interface 27 or an image source, and processes the data into raw image data or into a format that is readily processed into raw image data. The processor 21 then sends the processed data to the driver controller 29 or to frame buffer 28 for storage. Raw data typically refers to the information that identifies the image characteristics at each location within an image. For example, such image characteristics can include color, saturation, and gray-scale level.

In one embodiment, the processor 21 includes a microcontroller, CPU, or logic unit to control operation of the exemplary display device 40. Conditioning hardware 52 generally includes amplifiers and filters for transmitting signals to the speaker 45, and for receiving signals from the microphone 46. Conditioning hardware 52 may be discrete components within the exemplary display device 40, or may be incorporated within the processor 21 or other components.

The driver controller 29 takes the raw image data generated by the processor 21 either directly from the processor 21 or from the frame buffer 28 and reformats the raw image data appropriately for high speed transmission to the array driver 22. Specifically, the driver controller 29 reformats the raw image data into a data flow having a raster-like format, such that it has a time order suitable for scanning across the display array 30. Then the driver controller 29 sends the formatted information to the array driver 22. Although a driver controller 29, such as a LCD controller, is often associated with the system processor 21 as a stand-alone Integrated Circuit (IC), such controllers may be implemented in many ways. They may be embedded in the processor 21 as hardware, embedded in the processor 21 as software, or fully integrated in hardware with the array driver 22.

Typically, the array driver 22 receives the formatted information from the driver controller 29 and reformats the video data into a parallel set of waveforms that are applied many times per second to the hundreds and sometimes thousands of leads coming from the display's x-y matrix of pixels.

In one embodiment, the driver controller 29, array driver 22, and display array 30 are appropriate for any of the types of displays described herein. For example, in one embodiment, driver controller 29 is a conventional display controller or a bi-stable display controller (e.g., an interferometric modulator controller). In another embodiment, array driver 22 is a conventional driver or a bi-stable display driver (e.g., an interferometric modulator display). In one embodiment, a driver controller 29 is integrated with the array driver 22. Such an embodiment is common in highly integrated systems such as cellular phones, watches, and other small area displays. In yet another embodiment, display array 30 is a typical display array or a bi-stable display array (e.g., a display including an array of interferometric modulators).

The input device 48 allows a user to control the operation of the exemplary display device 40. In one embodiment, input device 48 includes a keypad, such as a QWERTY keyboard or a telephone keypad, a button, a switch, a touch-sensitive screen, a pressure- or heat-sensitive membrane. In one embodiment, the microphone 46 is an input device for the exemplary display device 40. When the microphone 46 is used to input data to the device, voice commands may be provided by a user for controlling operations of the exemplary display device 40.

Power supply 50 can include a variety of energy storage devices as are well known in the art. For example, in one embodiment, power supply 50 is a rechargeable battery, such as a nickel-cadmium battery or a lithium ion battery. In another embodiment, power supply 50 is a renewable energy source, a capacitor, or a solar cell, including a plastic solar cell, and solar-cell paint. In another embodiment, power supply 50 is configured to receive power from a wall outlet.

In some implementations control programmability resides, as described above, in a driver controller which can be located in several places in the electronic display system. In some cases control programmability resides in the array driver 22. The above-described optimization may be implemented in any number of hardware and/or software components and in various configurations.

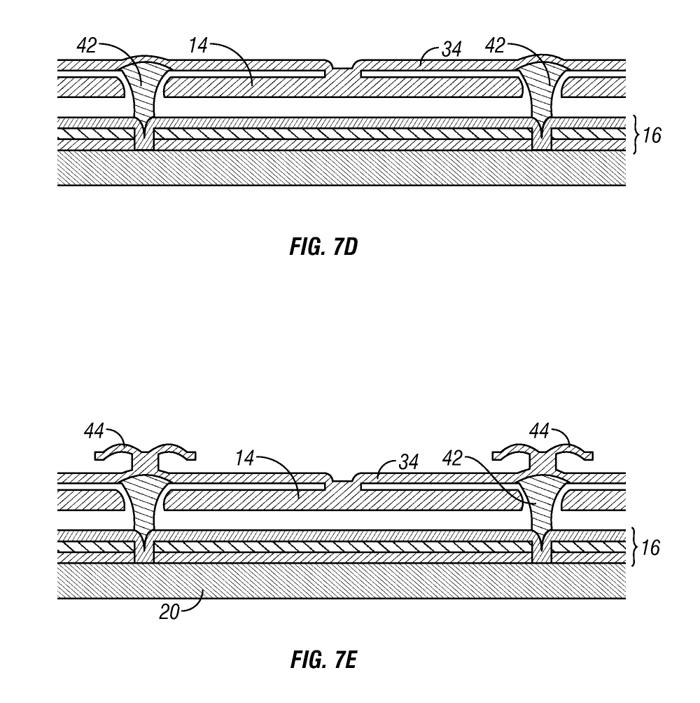

The details of the structure of interferometric modulators that operate in accordance with the principles set forth above may vary widely. For example, FIGS. 7A-7E illustrate five different embodiments of the movable reflective layer 14 and its supporting structures. FIG. 7A is a cross section of the embodiment of FIG. 1, where a strip of metal material 14 is deposited on orthogonally extending supports 18. In FIG. 7B, the moveable reflective layer 14 of each interferometric modulator is square or rectangular in shape and attached to supports at the corners only, on tethers 32. In FIG. 7C, the moveable reflective layer 14 is square or rectangular in shape and suspended from a deformable layer 34, which may comprise a flexible metal. The deformable layer 34 connects, directly or indirectly, to the substrate 20 around the perimeter of the deformable layer 34. These connections are herein referred to as support posts. The embodiment illustrated in FIG. 7D has support post plugs 42 upon which the deformable layer 34 rests. The movable reflective layer 14 remains suspended over the gap, as in FIGS. 7A-7C, but the deformable layer 34 does not form the support posts by filling holes between the deformable layer 34 and the optical stack 16. Rather, the support posts are formed of a planarization material, which is used to form support post plugs 42. The embodiment illustrated in FIG. 7E is based on the embodiment shown in FIG. 7D, but may also be adapted to work with any of the embodiments illustrated in FIGS. 7A-7C as well as additional embodiments not shown. In the embodiment shown in FIG. 7E, an extra layer of metal or other conductive material has been used to form a bus structure 44. This allows signal routing along the back of the interferometric modulators, eliminating a number of electrodes that may otherwise have had to be formed on the substrate 20.

In embodiments such as those shown in FIG. 7, the interferometric modulators function as direct-view devices, in which images are viewed from the front side of the transparent substrate 20, the side opposite to that upon which the modulator is arranged. In these embodiments, the reflective layer 14 optically shields the portions of the interferometric modulator on the side of the reflective layer opposite the substrate 20, including the deformable layer 34. This allows the shielded areas to be configured and operated upon without negatively affecting the image quality. For example, such shielding allows the bus structure 44 in FIG. 7E, which provides the ability to separate the optical properties of the modulator from the electromechanical properties of the modulator, such as addressing and the movements that result from that addressing. This separable modulator architecture allows the structural design and materials used for the electromechanical aspects and the optical aspects of the modulator to be selected and to function independently of each other. Moreover, the embodiments shown in FIGS. 7C-7E have additional benefits deriving from the decoupling of the optical properties of the reflective layer 14 from its mechanical properties, which are carried out by the deformable layer 34. This allows the structural design and materials used for the reflective layer 14 to be optimized with respect to the optical properties, and the structural design and materials used for the deformable layer 34 to be optimized with respect to desired mechanical properties.

Some of the embodiments of the invention relate to an apparatus and methods for updating a display. In on particular embodiment, an apparatus for selectively skipping the updates of portions of the display is provided. A significant amount of the power consumed in a display may be expended when updating portion of the display. Thus, to reduce power consumption, it may be desirable to decrease the amount of updating that is done. However, it is also desirable to minimize the effect of skipping updates on the visual experience of the user. Thus, it is desirable to use a scheme which selects updates to skip while minimizing visual artifacts. However, as the implementation of such a scheme may itself involve the use of power and other resources, it may be desirable to minimize the complexity and power used to identify updates to be skipped. In one embodiment, systems and methods for minimizing the complexity and power use when selecting updates to skip is described.

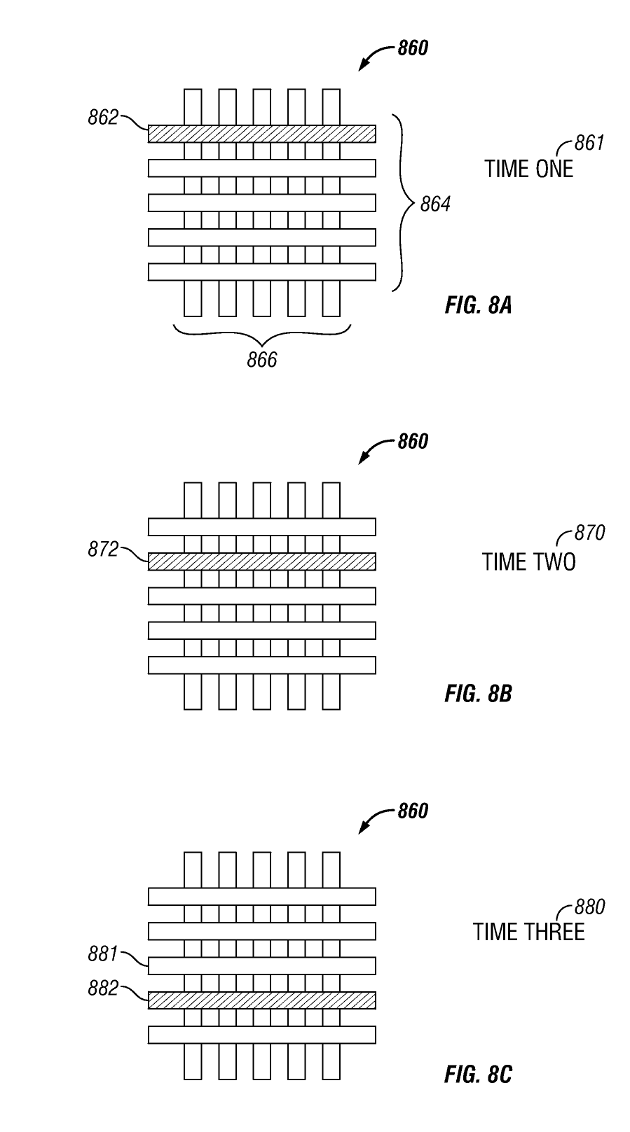

FIGS. 8A, 8B, and 8C illustrate an exemplary update sequence for a display apparatus 860. The display apparatus 860 may be similar to the display array 30 of FIG. 2. The display apparatus 860 comprises a plurality of common lines 864 and a plurality of segment lines 866. The intersections of the common lines 864 and segment lines 866 represent interferometric modulators. As described above, at a first point in time 861, a particular common line 862 may be scheduled to be updated. For the purpose of explanation, the data to be written to the common line 862 may be referred to as a unit of display data. In one embodiment a unit of display data may comprise a representation of the intended state of the interferometric modulators in the corresponding portion of the display apparatus 860. For example, the unit of display data may comprise a plurality of binary numbers indicating whether the interferometric modulators along the common line 862 are to be actuated or released. In other embodiments, a unit of display data may correspond to data for a plurality of common lines, an entire frame, a single pixel or some other portion of the display apparatus 860. As described above, the unit of display data may be written to the common line 862 by the selective application of voltages to the common line 862 and the segment lines 866.

At a second time 870, another unit of display data may be written to the common line 872 of the display apparatus 860 as depicted in FIG. 8B. At a third time 880, another unit of display data may be written to the common line 882 of the display apparatus 860 as depicted in FIG. 8C. However, as illustrated, the common line 881 has not been updated. As described above, it may be desirable to not update common line 881 for one or more reasons. For example, by not updating common line 881, power used in the update process may be conserved. It may be acceptable to skip the update of common line 881 if updated display data for common line 881 is sufficiently similar or the same as the display data already written to the common line 881. In this case, skipping the update of common line 881 may be visually unnoticeable to an end user and may conserve power. As described below, in one embodiment systems and methods for efficiently determining the similarity between display data already being displayed and updated display data is provided.

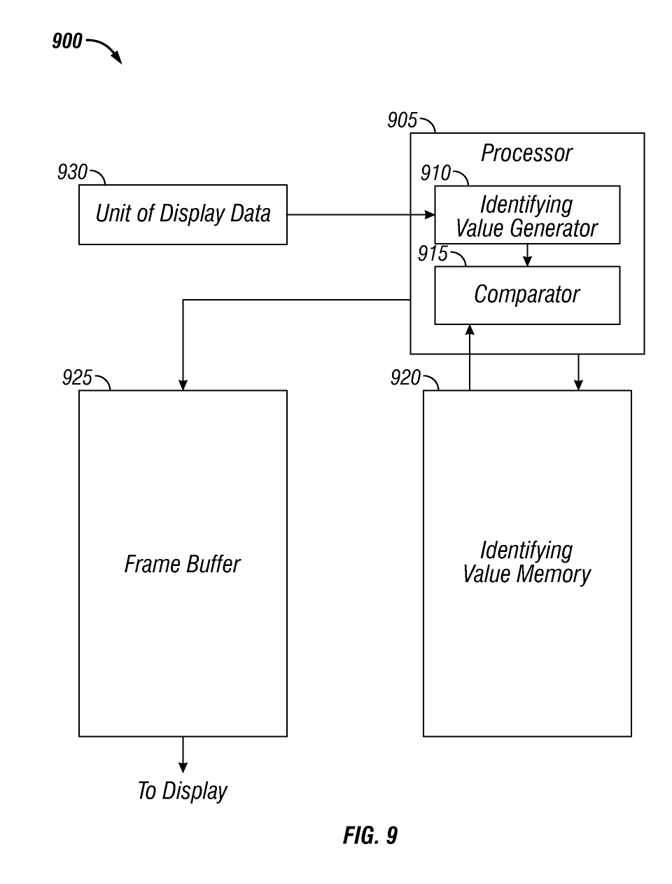

FIG. 9 is a system block diagram illustrating an embodiment of an update apparatus 900. The update apparatus 900 may be functionally similar to portions of the display device 40 of FIG. 6B. The update apparatus 900 comprises a processor 905, an identifying value memory 920, and a frame buffer 925. The processor 905 further comprises an identifying value generator 910 and a comparator 915. The processor 905 is configured to receive units of display data 930 and to selectively write the units of display data 930 to the frame buffer 925. The processor is further configured to receive and write identifying values to and from the identifying value memory 920. The identifying value generator 910 is configured to generate an identifying value for the unit of display data 930 and to provide the identifying value to the comparator 915. The comparator is configured to receive identifying values from the identifying value generator 910 and from the identifying value memory 920.

In one aspect, the processor 905 is configured to direct the flow of information between elements of the update apparatus 900. In particular, the processor determines whether or not a newly received unit of display data 930 is written to the frame buffer 925. As described herein, in one embodiment, this determination is made based, at least in part on identifying values for the received unit of display data 930 and an identifying value for a previously received unit of display data. In one embodiment the processor 905 may be any general purpose single- or multi-chip microprocessor such as an ARM®, Pentium®, 8051, MIPS®, Power PC®, or ALPHA®, or any special purpose microprocessor such as a digital signal processor, microcontroller, or a programmable gate array. As is conventional in the art, the processor 905 may be configured to execute one or more software modules.

In one aspect, the identifying value generator 910 is configured to generate identifying values for a received unit of display data 930. As used herein, an identifying value comprises a value which may be used to identify the unit of display data from which it is generated. For example, the identifying value generator 910 may be implemented as circuitry or software for performing a hash function. In one embodiment, the hash function may be a cyclical redundancy check (CRC) function. The unit of display data 930 may be treated as the input to the CRC function and the output of the CRC function may be considered the identifying value. While different units of display data may result in the same identifying values after passing through the CRC function, the particular code used for the CRC function may be selected such that such collisions occur infrequently for the normal range of inputs to the identifying value generator. In one specific embodiment, the identifying value generator 910 may be implemented as a 16 bit CRC. Thus regardless of the size of the unit of display data 930, the identifying value is only 16 bits long. For example, if the unit of display data corresponds to a single common line worth of display data and the common line comprised 1024 pixels using a single bit each to represent their respective states, the identifying value would represent a reduction in size from 1024 bits for the unit of display data to 16 bits for the identifying value. This significantly reduces the memory reads and writes necessary to determine whether two units of display data are the same. In one embodiment, the identifying value generator 910 may be implemented in hardware as an arithmetic logic unit or other logical circuit. Alternatively, the identifying value generator 910 may be implemented as a software module or computer instructions executed by the processor 905. While illustrated as a component of the processor 905, the identifying value generator 910 may be implemented separately from the processor 905 as a stand alone unit or as a component of another system element.

In one embodiment, the comparator 915 is configured to compare identifying values for different units of display data. For example, during a previous update, a first identifying value for a first unit of display data corresponding to a particular common line may have been determined. Subsequently, during a current update, a second of display data corresponding to the same common line may be received and a second identifying value for the second unit of display data may be determined. The comparator 915 may be configured to compare the first and second identifying values. As described further below, the processor 905 may use the result of the comparison to determine whether or not to update the particular common line with the second unit of display data. In one embodiment, the comparator 915 may receive the first identifying value from a memory configured to hold identifying values generated during previous updates such as the identifying value memory 920. Further, the comparator 915 may receive the second identifying value from the identifying value generator 910 as the identifying values for new units of display data are generated. In one embodiment, the comparator 915 may be implemented in hardware as an arithmetic logic unit or other logical circuit. Alternatively, the comparator 915 may be implemented as a software module or computer instructions executed by the processor 905. While illustrated as a component of the processor 905, the identifying value generator 910 may be implemented separately from the processor 905 as a stand alone unit or as a component of another system element.

The frame buffer 925 is similar to the frame buffer 28 of FIG. 6B. The frame buffer stores units of display data which are written to the display. In one embodiment, when a unit of display data corresponding to a particular common line is received and the identifying value is different than the identifying value of the previously received unit of display data for the particular common line, the unit of display data is written to the frame buffer 925.

The identifying value memory 920 is a memory configured to store identifying values of units of display data. The identifying values may be read from the identifying value memory 920 in order to determine if a newly received unit of display data should be written to the frame buffer 926 and display. Identifying values for units of display data which are written to the frame buffer may be written to the identifying value memory 920 as well. The identifying value memory 920 may be implemented using one or more different storage technologies. Further, the identifying value memory may be implemented as a component of the processor 905 or the frame buffer 925.

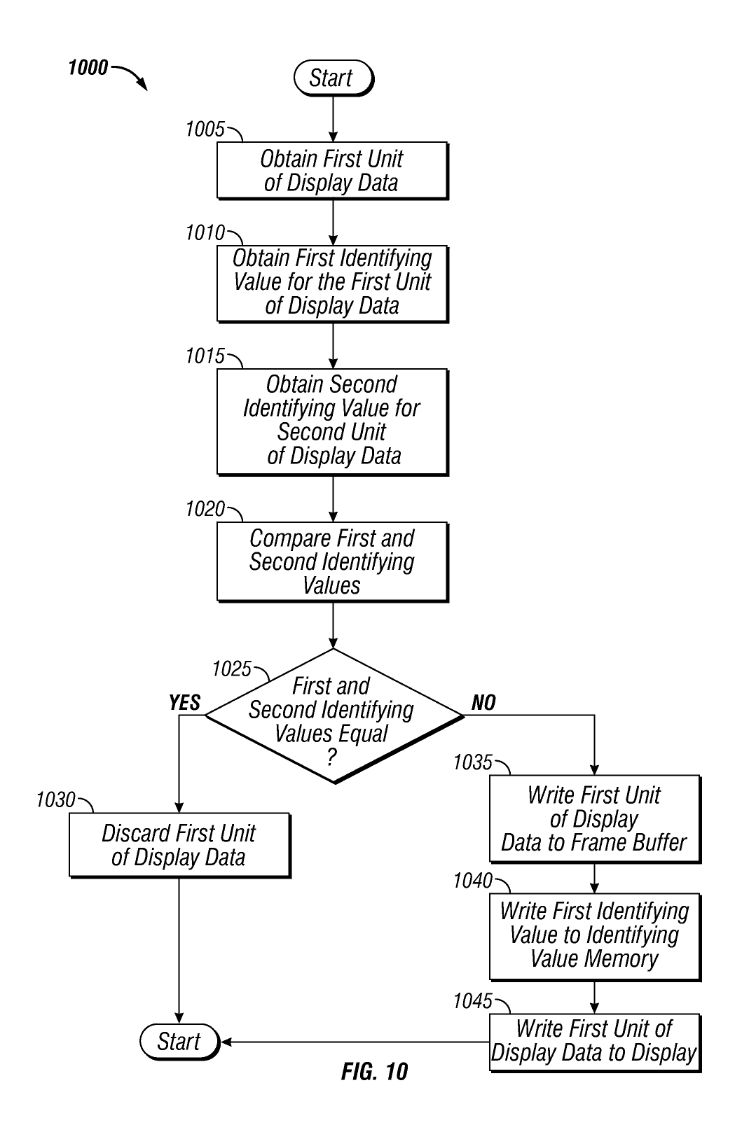

FIG. 10 is a flowchart of an embodiment of a process 1000 for updating a display. The process 1000 may be implemented by the display apparatus 900. At block 1005, a unit of display data is obtained. As described above the processor 905 may receive the unit of display data 930. The unit of display data 930 may come from an input device such as the input device 48 of FIG. 6E. The unit of display data may correspond to data for an entire frame, one or more common lines, or some other portion of the display. At block 1010, a first identifying value for the unit of display data is obtained. In one embodiment the identifying value generator 910 performs an operation on the unit of display data 930 to generate the first identifying value. In one embodiment, the operation may be a hash function or CRC function. At block 1015, a second identifying value for a second unit of display data is obtained. In one embodiment, the first and second units of display data correspond to a same portion of the display such as a same common line. The second unit of display data represents display data received during a previous update and the first unit of display data represents display data received during a current update. In one embodiment, the second identifying value is obtained by retrieving the second identifying value from the identifying value memory 920. At block 1020, the first and second identifying values are compared. In one embodiment, the comparison is performed by the comparator 915.

At block 1025, flow of the process 1000 branches responsive to the comparison of the first and second identifying values. In one embodiment, equivalence is the comparison operation. In other embodiments, other comparisons such as difference, XOR, or other logical or mathematical comparisons may be used. If the first and second identifying values are equivalent 1025 (YES), the first unit of display data is discarded as described at block 1030. This discarding may be performed by the processor 905. As a result, the portion of the display to which the first unit of display data corresponds may not be updated.

Alternatively, if the first and second identifying values are not equivalent 1025 (NO), the first unit of display data is written to the frame buffer as illustrated at block 1035. In one embodiment, the processor 905 may write the unit of display data to the frame buffer 925. At block 1040, the first identifying value 1040 is written to the identifying value memory. In one embodiment, the processor 905 may write the first identifying value to the identifying value memory 920. In this manner, the first identifying value may be used during subsequent updates to determine if the updated unit of display data should be written to the display. The first identifying value may overwrite the second identifying value in the identifying value memory 920. At block 1045, the first unit of display data may be written to the display. In one embodiment, this actual update of the display may be accomplished as described above with respect to FIGS. 2, 6B, and 8.

Advantageously, the present systems and methods provide for a power efficient way to determine whether or not display data should be written to the display. For example, power expenditure is reduced because determining similarity of units of display data can be accomplished by comparing relatively small identifying values. Further, by storing these values in a memory separate from the frame buffer, the number of reads and writes to the frame buffer can be greatly reduced.

What is claimed is:

1. A method of updating a display, the method comprising:
obtaining a first identifying value corresponding to a first unit of display data;
obtaining a second identifying value corresponding to a second unit of display data;
comparing the first and second identifying values; and
selectively writing the first unit of display data to a display based, at least in part, on the comparison.

2. The method of claim 1 wherein the first unit of display data is written if the first and second identifying values are not equal.

3. The method of claim 1 wherein the first and second identifying values comprise hash values.

4. The method of claim 1 wherein the first and second identifying values comprise cyclical redundancy check codes.

5. The method of claim 1 wherein the first and second units of display data each correspond to data for a respective line of a display array.

6. The method of claim 1 further comprising selectively discarding the first unit of display data based, at least in part, on the comparison.

7. The method of claim 6 wherein the first unit of display data is discarded if the first and second identifying values are equal.

8. The method of claim 1 wherein obtaining the second identifying value comprises receiving the second identifying value from a memory storing one or more identifying values.

9. The method of claim 1 wherein obtaining the first identifying value comprises:
receiving the first unit of display data; and
computing the first identifying value based, at least in part, on the second unit of display data.

10. The method of claim 1, wherein writing the first unit of display data to the display comprises:
writing the first unit of display data to a frame buffer; and
writing the first identifying value to a memory storing one or more identifying values.

11. An apparatus for updating a display, the apparatus comprising:
a processor configured to:
obtain a first identifying value based corresponding to a first unit of display data;
obtain a second identifying value based corresponding to a second unit of display data;
compare the first and second identifying values; and
selectively write the first unit of display data to a display based, at least in part, on the comparison.

12. A display apparatus, the apparatus comprising:
a memory storing one or more identifying values corresponding to respective units of display data, wherein the identifying values comprise less data than the corresponding units of display data; and
a frame buffer storing the corresponding units of display data.

13. The display apparatus of claim 12, further comprising an identifying value generator configured to generate a first identifying value based, at least in part, on a first unit of display data.

14. The display apparatus of claim 13, further comprising a comparator configured to compare the first identifying value with one of the one or more identifying values from the memory.

15. The display apparatus of claim 12, further comprising an input device configured to deliver the corresponding units of display data.

16. The display apparatus of claim 12, further comprising a display array configured to display the corresponding units of display data.

17. The display apparatus of claim 16, wherein the display array comprises a plurality of interferometric modulators.

18. The display apparatus of claim 16, further comprising an array driver configured to write the corresponding units of display data to the display array.

19. An apparatus for updating a display, the apparatus comprising
means for obtaining a first identifying value corresponding to a first unit of display data;
means for obtaining a second identifying value corresponding to a second unit of display data;
means for comparing the first and second identifying values; and
means for selectively writing the first unit of display data to a display based, at least in part, on the comparison.

20. A computer program product comprising:
a computer-readable medium having stored thereon, computer executable instructions that, if executed by an apparatus, cause the apparatus to perform a method comprising:
obtaining a first identifying value corresponding to a first unit of display data;
obtaining a second identifying value corresponding to a second unit of display data;
comparing the first and second identifying values; and
selectively writing the first unit of display data to a display based, at least in part, on the comparison.
